(19) United States
(12) Patent Application Publication
(10) Pub. No.: US 2026/0064676 A1
(43) Pub. Date: Mar. 5, 2026

(54) SYSTEM AND METHOD FOR PROVIDING AN INTERACTIVE DIGITAL ASSISTANT ACTION INTERFACE FOR USE WITH A DATA ANALYTICS ENVIRONMENT

(71) Applicant: ORACLE INTERNATIONAL CORPORATION, Redwood Shores, CA (US)

(72) Inventors: Praveen Upadhyay, Bengaluru (IN); Abhijit B, Bengaluru (IN); Akhil Hooda, Delhi (IN); Talapally Sandeep Kumar, Bengaluru (IN); Tushika Singh, Bengaluru (IN)

(21) Appl. No.: 19/307,938

(22) Filed: Aug. 22, 2025

Related U.S. Application Data
(60) Provisional application No. 63/690,570, filed on Sep. 4, 2024.

(51) Int. Cl. G06F 16/2452; G06F 9/451; G06F 16/248

(52) U.S. Cl. CPC G06F 16/24522; G06F 9/453; G06F 16/248

(57) ABSTRACT

An interactive digital assistant action interface includes a computer including processors that provide access to a data analytics environment, a chat-assistance service or application, and a large language model (LLM). The chat-assistance service or application delivers to the LLM a prompt corresponding to a received query and a desired task is determined based on the LLM receiving the prompt. One or more processes, steps, and/or APIs of the determined desired task are executed at the data analytics environment, and results of the one or more processes, steps, and/or APIs of the determined desired task being executed at the data analytics environment are provided.

### CLAIM OF PRIORITY AND CROSS-REFERENCE TO RELATED APPLICATIONS

This application claims the benefit of priority to U.S. Provisional Patent Application titled “SYSTEM AND METHOD FOR USE WITH A DATA ANALYTICS ENVIRONMENT TO PROVIDE A CHAT ACTION INTERFACE,” Application No. 63/690,570, filed Sep. 4, 2024; which above application and the contents thereof is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for use with a data analytics environment to provide an interactive digital assistant action interface.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

In modern professional settings, employees and other users often need to perform many repetitive and manual tasks. These may include, for example, document management tasks, project setup tasks, and other daily routine office work. These tasks not only consume significant amounts of time but also divert attention from more valuable activities that demand creativity and strategic thinking.

Despite having processes defined and in place for these repetitive and manual tasks, and application program interfaces (APIs) available, and other steps in place, employees and other users typically still resort to traditional manual command and data entry methods because tools fully automating those tasks end-to-end are generally unavailable.

Data and command entry may be entered by the employees and other users through text, voice, or uploads. However, the integration of such digital tools across various platforms is less than seamless, resulting in inefficiencies and a fragmented user experience.

Currently, AI often directs how tasks should be performed such as by providing to the users lists of steps or other actions to be taken by the user, and the employees and other users simply manually follow the instructions that are provided by the AI tools.

Furthermore, in an era dominated by generative artificial intelligence (AI) technologies such as various large language models (LLMs) available from Oracle® there is a growing expectation to enhance basic question-and-answer capabilities. The current need is for AI systems that can not only understand commands but that can also perform real actions on behalf of the users, thereby transforming simple question-and-answer digital assistants into proactive tools that enhance workplace productivity and streamline complex workflows.

It is therefore desirable to provide an interactive digital assistant action interface that is able to focus on handling daily office and personal tasks through voice commands, text commands, and/or file uploads, wherein users may simply state what they want to be done, and the interactive digital assistant action interface will actively execute the commands.

### SUMMARY

Embodiments described herein are generally related to data analytics environments, and are particularly directed to systems and methods for use with a data analytics environment to provide an interactive digital assistant action interface. In accordance with an embodiment, the systems and methods can utilize a machine learning model large language model (LLM).

In any of the implementations herein, systems and methods are provided for use with a data analytics environment to provide an interactive digital assistant that uses AI such as for example a LLM to receive job requests from employees and other users, to interpret the received job requests, and to execute one or more processes, steps, and/or APIs associated with the interpreted received job requests on behalf of the employees and other users.

In any of the implementations herein, systems and methods are provided for use with a data analytics environment to provide an interactive digital assistant that uses AI such as for example a LLM to receive job requests from employees and other users, to interpret the received job requests, and to automatically execute on behalf of the employees and other users one or more processes, steps, and/or APIs associated with the interpreted received job requests.

In accordance with an aspect, a system is provided for use with a data analytics environment to provide an interactive digital assistant interface for use with the data analytics environment.

The system includes a computer including one or more processors that provide access to a data analytics environment, a chat-assistance service or application running at the data analytics environment wherein the chat-assistance service or application is operable to receive a query, and a large language model (LLM) in a large language model environment running at the data analytics environment.

The chat-assistance service or application delivers to the LLM a prompt corresponding to the query received by the chat-assistance service or application, and a desired task is determined based on the LLM receiving the prompt, wherein the determined desired task comprises one or more processes, steps, and/or application programming interfaces (APIs).

One or more processes, steps, and/or APIs of the determined desired task are executed at the data analytics environment, and the chat-assistance service or application provides results of the one or more processes, steps, and/or APIs of the determined desired task being executed at the data analytics environment.

In any of the embodiments herein, the chat-assistance service or application of the system is operable to receive a natural language query from a client device, to translate the natural language query received from the client device to a translated query, and to communicate the translated query to the LLM as the prompt.

In any of the embodiments herein, the LLM of the system determines the desired task based on the prompt received by the LLM, and executes the one or more processes, steps, and/or APIs of the determined desired task. In addition, the chat-assistance service or application of the system provides results of the LLM executing the one or more processes, steps, and/or APIs of the determined desired task.

In any of the embodiments herein, the LLM of the system develops, based on training data and the prompt received by the LLM, a response representative of the determined desired task. In addition, the chat-assistance service or application of the system receives the response from the LLM and executes the one or more processes, steps, and/or APIs of the determined desired task, and also provides results of executing the one or more processes, steps, and/or APIs of the determined desired task.

In any of the embodiments herein, the system further includes an interface application operably coupled with the chat-assistance service or application running at the data analytics environment. In the embodiment, the interface application of the system is operable to provide a user interface, to receive a job request from a client user via the user interface, and to deliver the received a job request to the interface application as the query.

In any of the embodiments herein, the system further includes an integration layer application operably coupled with one or both of the chat-assistance service or application and/or the LLM. In the embodiment, the integration layer application provides a communication and control interface between one or both of the chat-assistance service or application and/or the LLM and application services internal or external to the data analytics environment. Also in the embodiment, one or both of the chat-assistance service or application and/or the LLM execute one or more of the APIs of the determined desired task using the application services internal or external to the data analytics environment via the integration layer application.

In any of the embodiments herein, one or both of the chat-assistance service or application and/or the LLM automatically execute the one or more processes, steps, and/or APIs of the determined desired task. In the embodiment, the chat-assistance service or application provides results of the one or more processes, steps, and/or APIs of the determined desired task being automatically executed.

In accordance with a further aspect, a method for use with a data analytics environment provides an interactive digital assistant interface use with the data analytics environment.

The method includes providing a computer including one or more processors, that provide access to a data analytics environment, providing a chat-assistance service or application running at the data analytics environment wherein the chat-assistance service or application is operable to receive a query, and providing a large language model (LLM) in a large language model environment running at the data analytics environment.

The method includes delivering by the chat-assistance service or application a prompt to the LLM, the prompt corresponding to the query received by the chat-assistance service or application, determining a desired task based on the LLM receiving the prompt, the determined desired task comprising one or more processes, steps, and/or application programming interfaces (APIs), executing the one or more processes, steps, and/or APIs of the determined desired task the data analytics environment, and providing by the chat-assistance service or application results of the one or more processes, steps, and/or APIs of the determined desired task being executed at the data analytics environment.

In any of the embodiments herein, the method further includes receiving by the chat-assistance service or application a natural language query from a client device, translating by the chat-assistance service or application the natural language query received from the client device to a translated query, and communicating by the chat-assistance service or application the translated query to the LLM as the prompt.

In any of the embodiments herein, the method further includes determining by the LLM the desired task based on the prompt received by the LLM, executing by the LLM the one or more processes, steps, and/or APIs of the determined desired task, and providing by the chat-assistance service or application results of the LLM executing the one or more processes, steps, and/or APIs of the determined desired task.

In any of the embodiments herein, the method further includes developing by the LLM, based on training data and the prompt received by the LLM, a response representative of the determined desired task, receiving by the chat-assistance service or application the response from the LLM and executing by the chat-assistance service or application the one or more processes, steps, and/or APIs of the determined desired task, and providing by the chat-assistance service or application results of executing the one or more processes, steps, and/or APIs of the determined desired task.

In any of the embodiments herein, the method further includes providing an interface application operably coupled with the chat-assistance service or application running at the data analytics environment. The method of the embodiment further includes providing by the interface application a user interface, receiving by the interface application a job request from a client user via the user interface, and delivering by the interface application the received a job request to the interface application as the query.

In any of the embodiments herein, the method further includes providing an integration layer application operably coupled with one or more of the chat-assistance service or application and/or the LLM. The method of the embodiment further includes providing by the integration layer application a communication and control interface between one or more of the chat-assistance service or application and/or the LLM and application services internal or external to the data analytics environment, and executing, by one or both of the chat-assistance service or application and/or the LLM, one or more of the APIs of the determined desired task using the application services internal or external to the data analytics environment via the integration layer application.

In any of the embodiments herein, the method further includes automatically executing, by one or both of the chat-assistance service or application and/or the LLM, the one or more processes, steps, and/or APIs of the determined desired task, and providing by the chat-assistance service or application results of the one or more processes, steps, and/or APIs of the determined desired task being automatically executed.

In accordance with a still further aspect, a non-transitory computer readable medium having instructions thereon is provided for use with a data analytics environment to provide an interactive digital assistant interface for use with the data analytics environment. The instructions of the non-transitory computer readable medium, when run and executed cause the computer to perform steps comprising providing a computer including one or more processors, wherein the computer provides access to the data analytics environment.

The instructions of the non-transitory computer readable medium, when run and executed cause the computer to perform further steps comprising providing a chat-assistance service or application running at the data analytics environment wherein the chat-assistance service or application is operable to receive a query, and providing a large language model (LLM) in a large language model environment running at the data analytics environment.

The instructions of the non-transitory computer readable medium, when run and executed cause the computer to perform further steps comprising delivering by the chat-assistance service or application a prompt to the LLM, the prompt corresponding to the query received by the chat-assistance service or application, and determining a desired task based on the LLM receiving the prompt, the determined desired task comprising one or more processes, steps, and/or application programming interfaces (APIs).

The instructions of the non-transitory computer readable medium, when run and executed cause the computer to perform further steps comprising executing the one or more processes, steps, and/or APIs of the determined desired task the data analytics environment, and providing by the chat-assistance service or application results of the one or more processes, steps, and/or APIs of the determined desired task being executed at the data analytics environment.

In any of the embodiments herein, the instructions of the non-transitory computer readable medium, when run and executed cause the computer to perform further steps comprising receiving by the chat-assistance service or application a natural language query from a client device, translating by the chat-assistance service or application the natural language query received from the client device to a translated query, and communicating by the chat-assistance service or application the translated query to the LLM as the prompt.

In any of the embodiments herein, the instructions of the non-transitory computer readable medium, when run and executed cause the computer to perform further steps comprising determining by the LLM the desired task based on the prompt received by the LLM, executing by the LLM the one or more processes, steps, and/or APIs of the determined desired task, and providing by the chat-assistance service or application results of the LLM executing the one or more processes, steps, and/or APIs of the determined desired task.

In any of the embodiments herein, the instructions of the non-transitory computer readable medium, when run and executed cause the computer to perform further steps comprising developing by the LLM based on training data and the prompt received by the LLM a response representative of the determined desired task, receiving by the chat-assistance service or application the response from the LLM and executing by the chat-assistance service or application the one or more processes, steps, and/or APIs of the determined desired task, and providing by the chat-assistance service or application results of executing the one or more processes, steps, and/or APIs of the determined desired task.

In any of the embodiments herein, the instructions of the non-transitory computer readable medium, when run and executed cause the computer to perform further steps comprising providing an interface application operably coupled with the chat-assistance service or application running at the data analytics environment, providing by the interface application a user interface, receiving by the interface application a job request from a client user via the user interface, and delivering by the interface application the received a job request to the interface application as the query.

In any of the embodiments herein, the instructions of the non-transitory computer readable medium, when run and executed cause the computer to perform further steps comprising providing an integration layer application operably coupled with one or more of the chat-assistance service or application and/or the LLM, providing by the integration layer application a communication and control interface between one or more of the chat-assistance service or application and/or the LLM and application services internal or external to the data analytics environment, and executing, by one or both of the chat-assistance service or application and/or the LLM, one or more of the APIs of the determined desired task using the application services internal or external to the data analytics environment via the integration layer application.

In any of the embodiments herein, the instructions of the non-transitory computer readable medium, when run and executed cause the computer to perform further steps comprising automatically executing, by one or both of the chat-assistance service or application and/or the LLM, the one or more processes, steps, and/or APIs of the determined desired task, and providing by the chat-assistance service or application results of the one or more processes, steps, and/or APIs of the determined desired task being automatically executed.

In any of the implementations herein, systems and methods are provided for use with a data analytics environment to provide an interactive digital assistant interface for use with the data analytics environment enabling employees and other users to be able to provide a request to the system and for the system to interpret the request, and to one or more processes, steps, and/or application programming interfaces (APIs) restore a previous version of a workbook with a single click input to the system.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates a system for use with a data analytics environment to provide an interactive digital assistant action interface, in accordance with an embodiment.

FIG. 12A illustrates a screenshot produced by a system for use with a data analytics environment to provide an interactive digital assistant action interface, in accordance with an embodiment.

FIG. 12B illustrates a screenshot produced by a system for use with a data analytics environment to provide an interactive digital assistant action interface, in accordance with an embodiment.

FIG. 12C illustrates a screenshot produced by a system for use with a data analytics environment to provide an interactive digital assistant action interface, in accordance with an embodiment.

FIG. 12D illustrates a screenshot produced by a system for use with a data analytics environment to provide an interactive digital assistant action interface, in accordance with an embodiment.

FIG. 12E illustrates a screenshot produced by a system for use with a data analytics environment to provide an interactive digital assistant action interface, in accordance with an embodiment.

FIG. 13 illustrates a screenshot produced by a system for use with a data analytics environment to provide an interactive digital assistant action interface, in accordance with an embodiment.

FIG. 14 illustrates a screenshot produced by a system for use with a data analytics environment to provide an interactive digital assistant action interface, in accordance with an embodiment.

FIG. 15 illustrates a screenshot produced by a system for use with a data analytics environment to provide an interactive digital assistant action interface, in accordance with an embodiment.

FIG. 16 illustrates a screenshot produced by a system for use with a data analytics environment to provide an interactive digital assistant action interface, in accordance with an embodiment.

FIG. 17 illustrates a screenshot produced by a system for use with a data analytics environment to provide an interactive digital assistant action interface, in accordance with an embodiment.

FIG. 18 illustrates a flowchart of a method for use with a data analytics environment to provide an interactive digital assistant action interface for use with a data analytics environment, in accordance with an embodiment

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

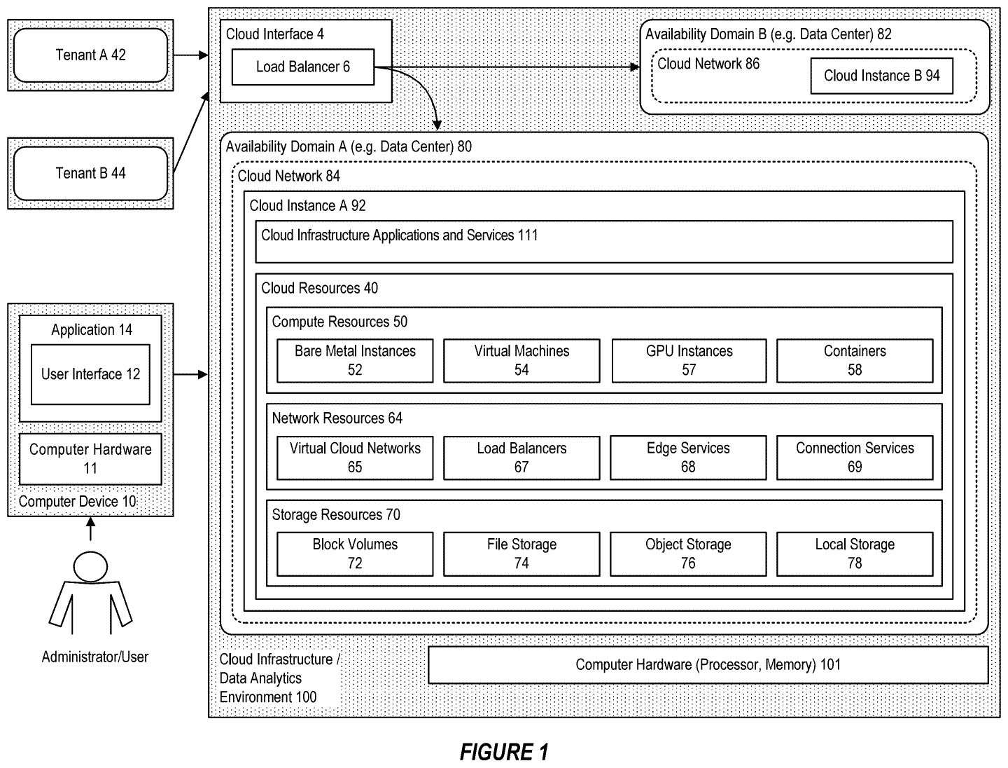

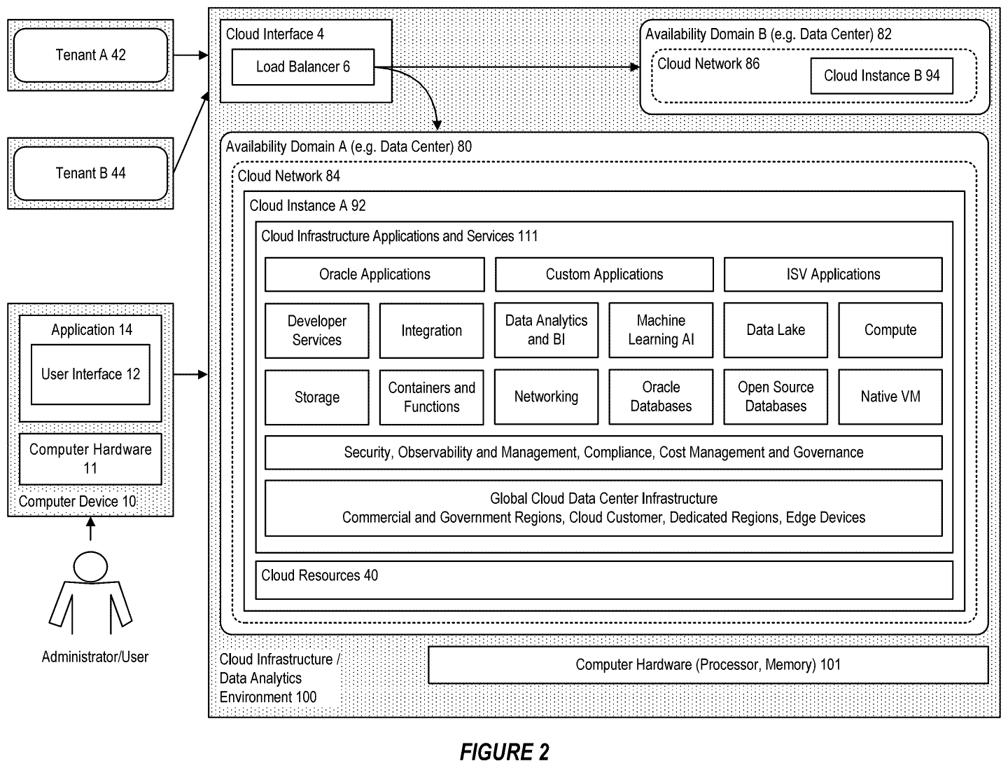

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

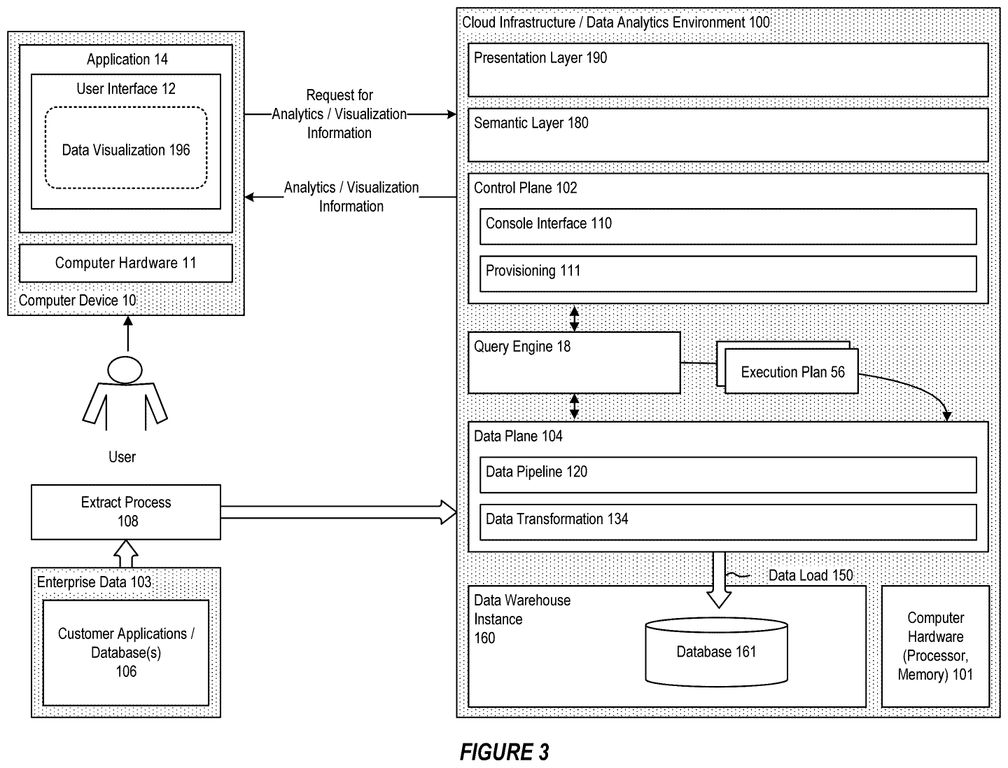

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer 270 to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

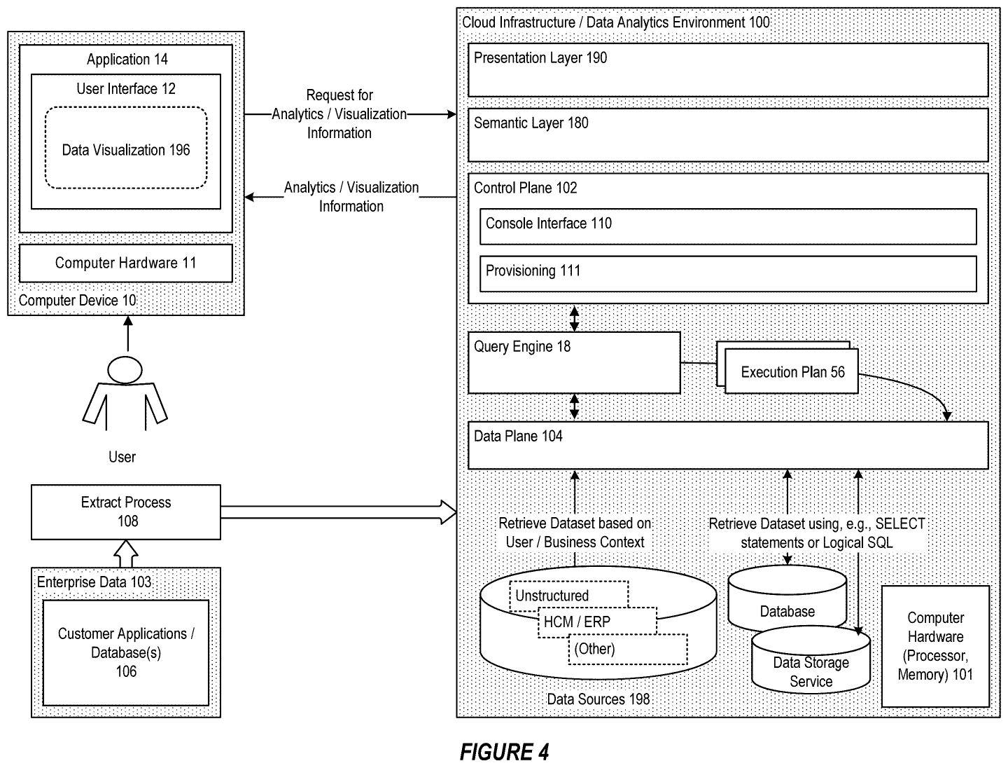

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

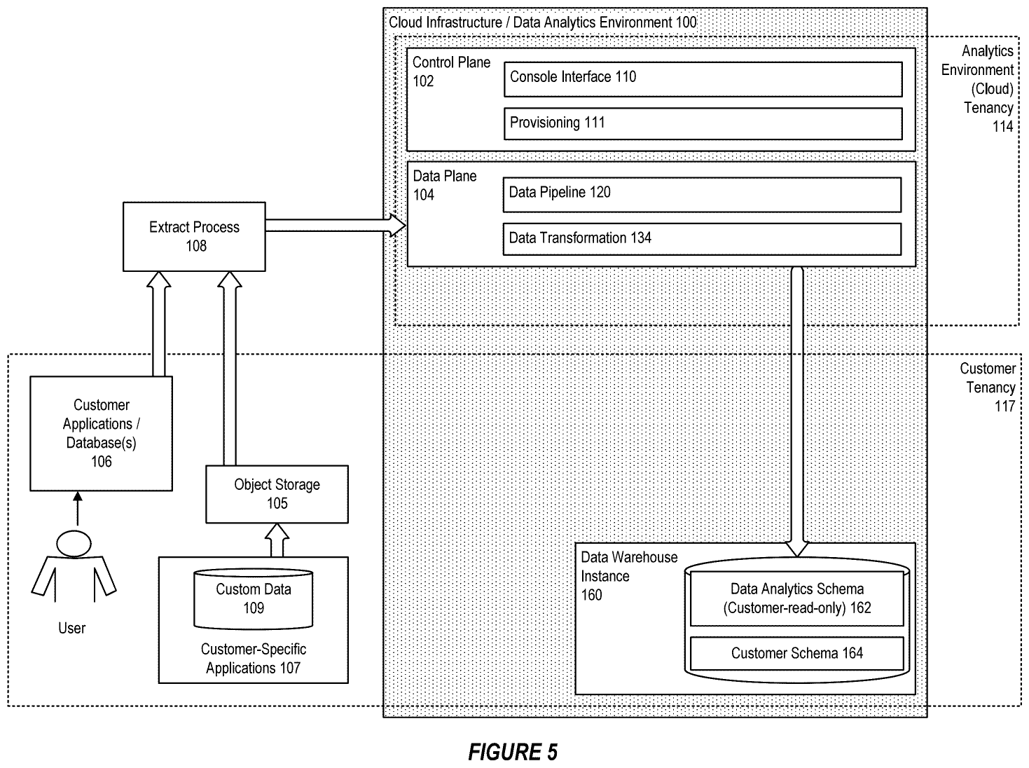

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

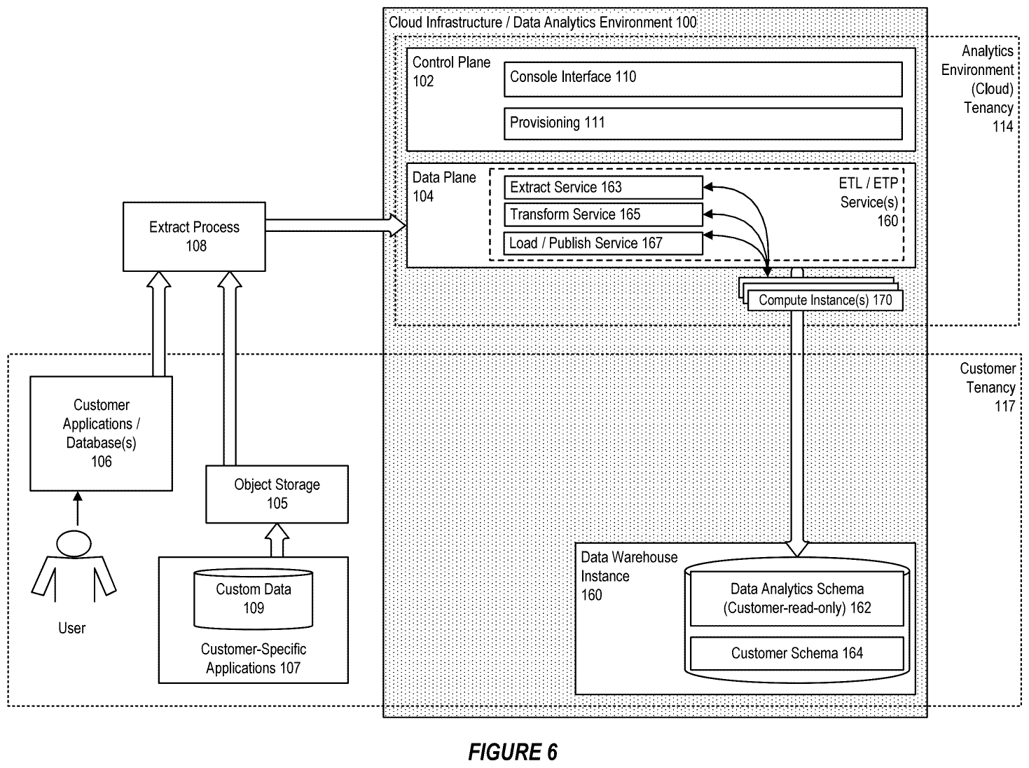

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

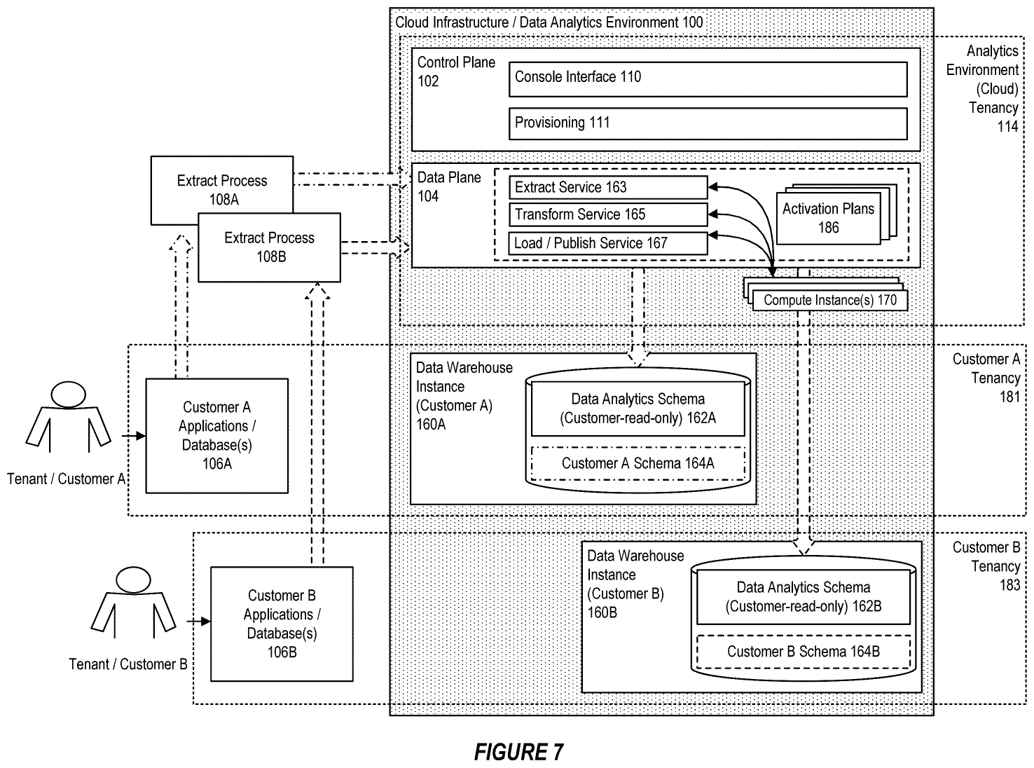

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

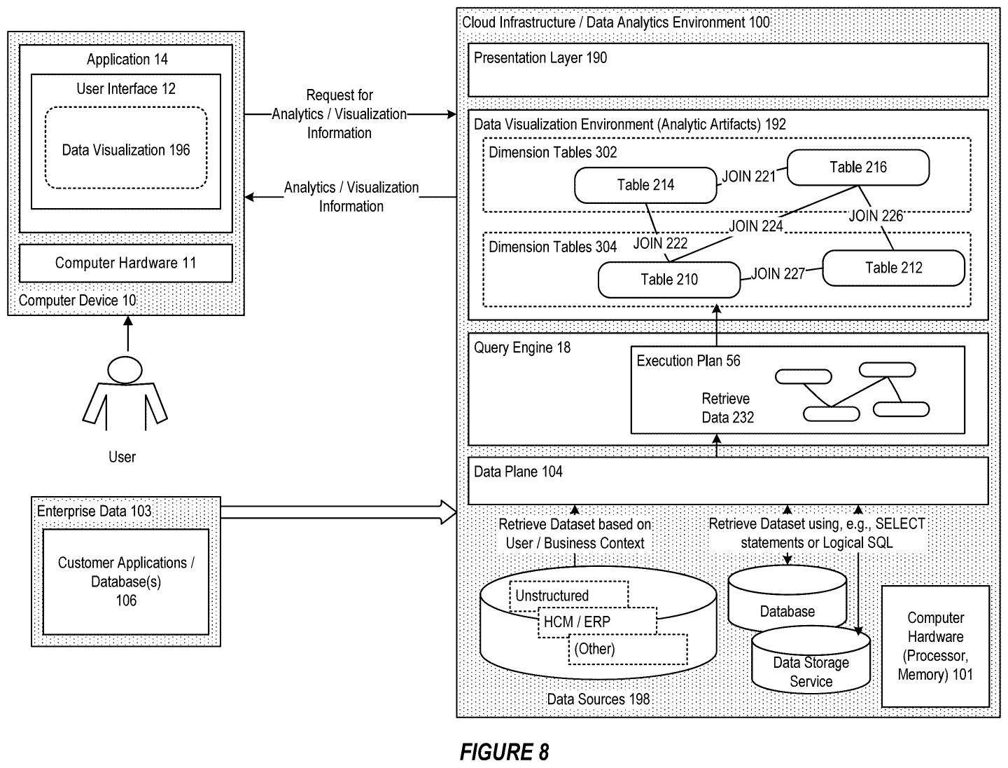

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

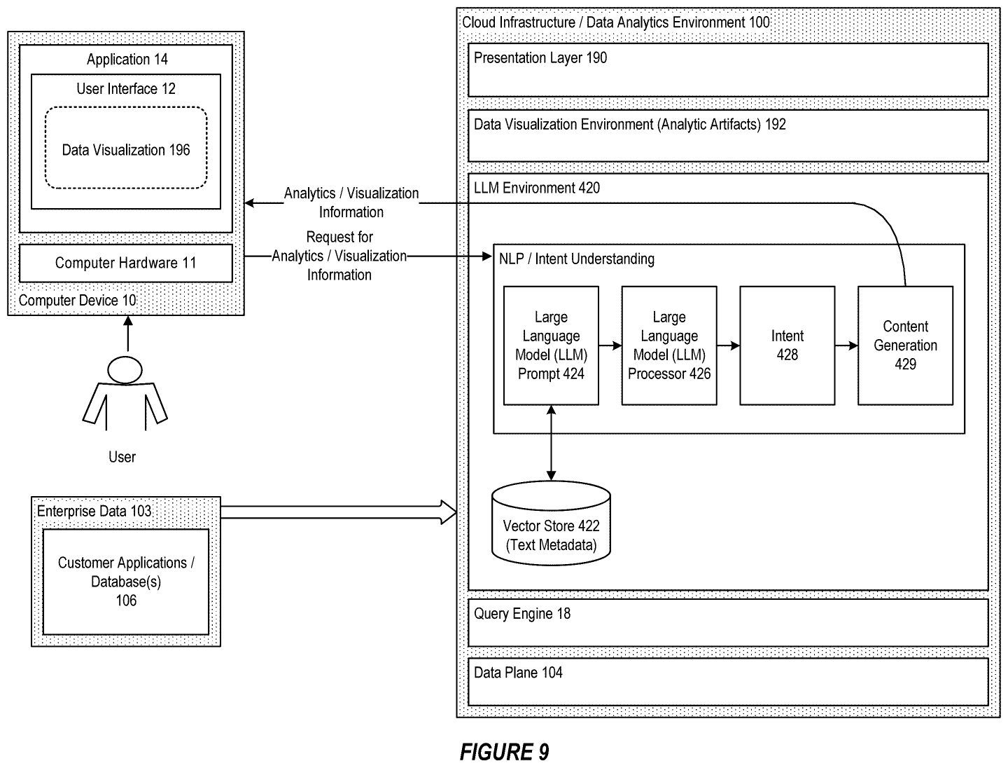

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

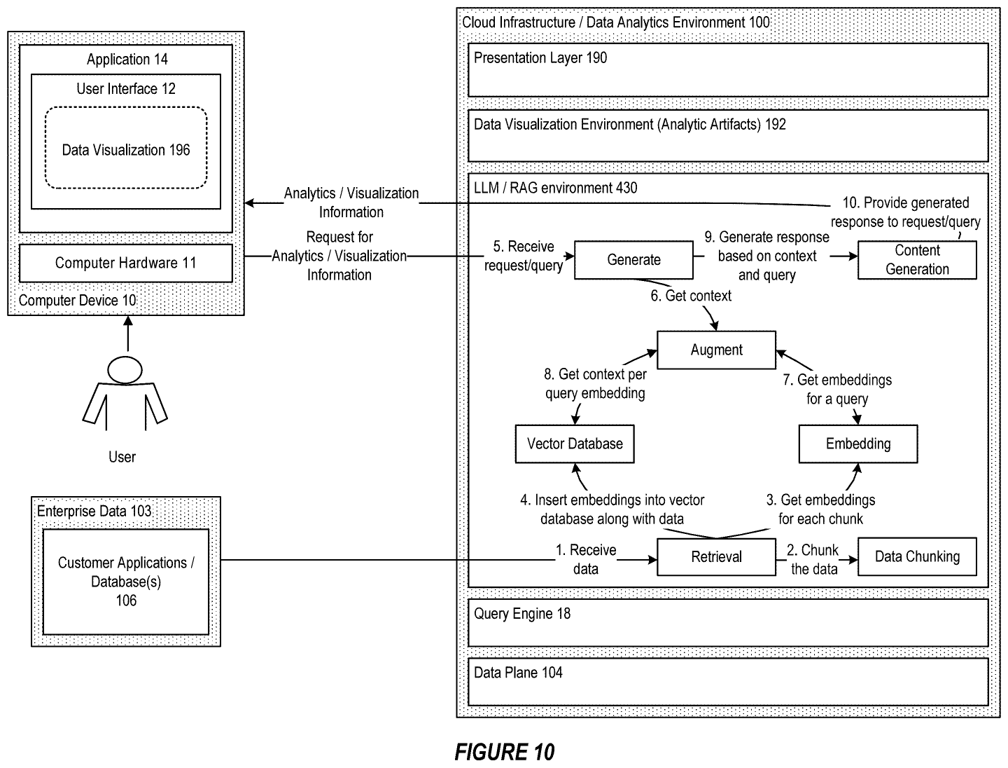

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process:

Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

### Interactive Digital Assistant Action Interface

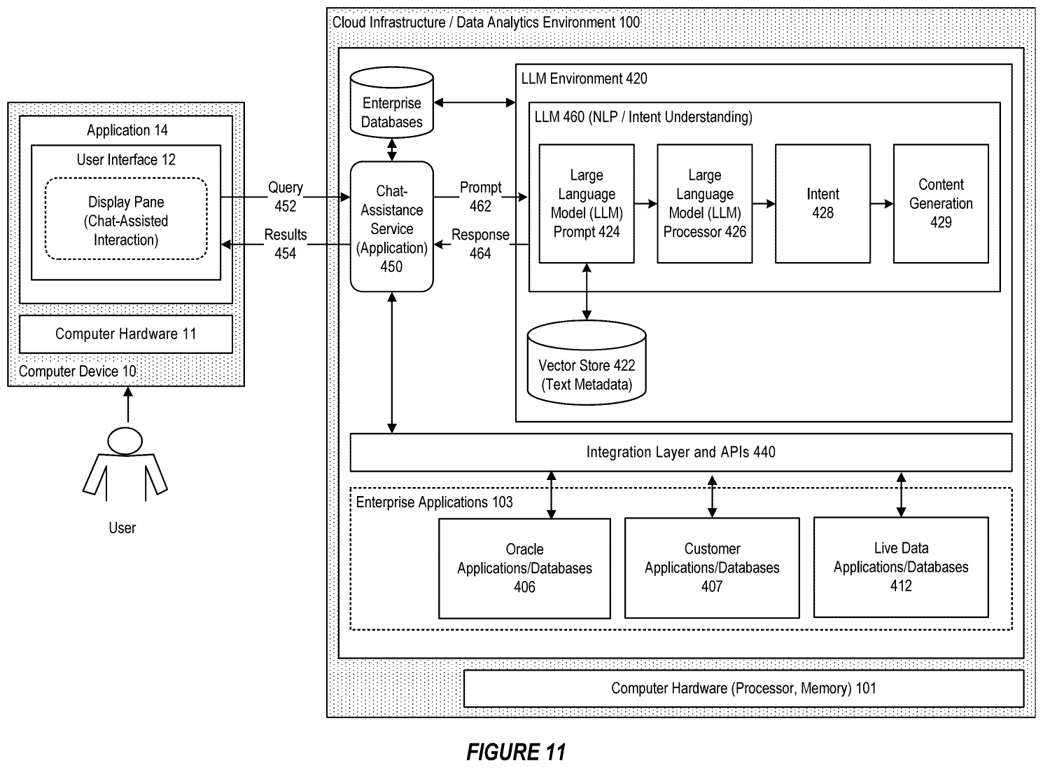

FIG. 11 illustrates a system for use with a data analytics environment to provide an interactive digital assistant action interface, in accordance with an embodiment.

In modern professional settings, employees often struck with repetitive and manual tasks like document management, project setup, and daily routine office work. Despite having defined processes, APIs, and steps in place, many still resort to traditional manual methods rather than issuing commands through text, voice, or uploads.

These tasks not only consume significant amounts of time but also divert attention from more valuable activities that demand creativity and strategic thinking. Additionally, the integration of digital tools across various platforms is frequently less than seamless, resulting in inefficiencies and a fragmented user experience.

Furthermore, in an era dominated by generative AI technologies like Oracle LLM, there is a growing expectation to enhance basic question-and-answer capabilities. The current need is for AI systems that can not only understand commands but also perform real actions-transforming digital assistants into proactive tools that enhance workplace productivity and streamline complex workflows.

Currently, AI often directs how tasks should be performed, and users simply follow its instructions. In accordance with an embodiment, an interactive digital assistant action interface or feature (referred to herein in some embodiments as ChatAction) operates to reverse this trend by enabling users to instruct AI on what needs to be done, allowing the AI to execute tasks on behalf of the users.

Unlike systems such as, for example, ChatGPT or Alexa, the interactive digital assistant action interface or feature (ChatAction) of the example implementations primarily focuses on handling daily office and personal tasks through voice commands, text, and/or file uploads. The subject interactive digital assistant action interface eliminates the need for users to worry about the fine details of commands and actions resulting from those commands. Rather, the users simply state what they would want to be done using voice, text, and/or file uploads, and the subject interactive digital assistant action interface takes care of it, leveraging advanced prompt engineering and Oracle LLM for excellent results.

In accordance with an embodiment, the subject interactive digital assistant action interface solution involves natural language processing (NLP), wherein the subject system and methods utilize large language models (LLMs) such as available from Oracle to understand and process commands in natural language, whether they are inputted by users via text, voice, or uploads. This allows users to interact with the digital action assistant in an intuitive and accessible manner, without requiring specialized knowledge or training.

In accordance with an embodiment, the subject interactive digital assistant action interface solution involves Task Automation and Management: By integrating with existing databases and software applications, particularly Oracle products, ChatAction can autonomously perform a variety of action-based tasks. These include creating and organizing project files, managing data archives, initiating complex sequences of operations across different APIs, and even handling specific cloud operations like interacting with Jira.

In accordance with an embodiment, the subject interactive digital assistant action interface solution involves Customizable Integration Framework: Designed with a focus on adaptability, ChatAction features a modular architecture that allows for seamless integration with various enterprise systems. This framework supports not only Oracle's ecosystem but can be adapted to work with other systems, enhancing the digital assistant's utility across different platforms and use cases.

In accordance with an embodiment, the subject interactive digital assistant action interface solution involves security and compliance components wherein based on an understanding of the importance of data security, particularly in corporate settings, the action interface includes robust security measures that ensure all interactions and data transfers are protected through encryption and compliance with international data protection standards.

In accordance with an embodiment, through these technical solutions, the subject interactive digital assistant action interface significantly reduces the time and effort required for routine tasks, enabling users and employees to focus on core business functions and improving overall organizational efficiency.

In accordance with an embodiment, the subject interactive digital assistant action interface offers several distinct aspects that differentiate it from existing solutions in the market including a proactive task management aspect, an integrated multimodal input aspect, deep integration with Oracle ecosystem, a customizable and scalable architecture aspect, an advanced security feature aspect, and extensive API interactions.

With regard to the proactive task management aspect, unlike traditional chatbots that primarily focus on reactive question-and-answer functionalities, the subject interactive digital assistant action interface is designed to proactively manage and execute a wide range of tasks. It not only responds to user queries but also anticipates needs based on user behavior and contextual data, offering suggestions and automating routine tasks without explicit user commands.

With regard to the integrated multimodal input aspect, the subject interactive digital assistant action interface uniquely incorporates a variety of input methods, for example, text, voice, and file uploads, into a single, cohesive system. This multimodal approach allows users to interact with the system in the most convenient way for their specific situation, enhancing usability and accessibility.

With regard to the deep integration with Oracle ecosystem, while many digital assistants offer some level of integration with external applications, subject interactive digital assistant action interface is specifically tailored to deeply integrate with Oracle's suite of products. This deep integration allows for seamless interactions across Oracle applications, enabling more complex actions and workflows that are not possible with generic AI solutions.

With regard to the customizable and scalable architecture aspect, the subject interactive digital assistant action interface features a highly customizable architecture that can be tailored to fit the specific needs of different Oracle users and departments. This adaptability ensures that as Oracle's products and customer needs evolve, the subject interactive digital assistant action interface evolves with them, providing a future-proof solution.

With regard to the advanced security feature aspect, security is a paramount concern in corporate environments. The subject interactive digital assistant action interface incorporates state-of-the-art security protocols that go beyond standard data protection measures. The subject interactive digital assistant action interface ensures all user interactions are secure and compliant with global data protection regulations, which is important for maintaining trust and integrity within business operations.

With regard to the extensive API interactions, the subject interactive digital assistant action interface leverages extensive API interactions not only to perform tasks but also to integrate disparate systems and data sources quickly and efficiently. This capability allows it to act as a bridge between different technologies within the Oracle ecosystem, facilitating smoother data flows and more coherent system functionality.

With reference to FIG. 11, a system for use with a data analytics environment to provide an interactive digital assistant action interface is illustrated in accordance with an embodiment.

The system includes a computer 101 including one or more processors that provide access to a data analytics environment 100, a chat-assistance service (application) 450 running at the data analytics environment 100, and a large language model (LLM) 460 in a large language model environment 420 running at the data analytics environment 100. The chat-assistance service 450 is operable to receive a query 452. In the example embodiment, the query 452 may be provided to the chat-assistance service 450 from a chat-assisted interaction display pane of the user interface 12.

The chat-assistance service 450 delivers to the LLM 460 a prompt 462 corresponding to the query 452 received by the chat-assistance service 450, and a desired task is determined based on the LLM 460 receiving the prompt 462, wherein the determined desired task comprises one or more processes, steps, and/or application programming interfaces (APIs) 440.

In accordance with an example implementation, the LLM 460 determines the desired task based on the query 452.

In accordance with a further example implementation, the LLM 460 together with the chat-assistance service 450 collaboratively determine the desired task based on the query 452.

In accordance with a still further example implementation, the chat-assistance service 450 determines the desired task based on a response 464 received by the chat-assistance service 450 from the LLM 460.

Further in accordance with the example implementation, one or more processes, steps, and/or APIs 440 of the determined desired task are executed at the data analytics environment 100, and the chat-assistance service 450 provides results 454 of the one or more processes, steps, and/or APIs 440 of the determined desired task being executed at the data analytics environment 100. In the example embodiment, the results 454 are provided to a chat-assisted interaction display pane of the user interface 12.

The one or more processes, steps, and/or APIs 440 that are executed at the data analytics environment 100 based on determined desired task may comprise executing one or more Oracle business productivity software applications and corresponding databases 406.

The one or more processes, steps, and/or APIs 440 that are executed at the data analytics environment 100 based on determined desired task may comprise executing one or more customer-specific applications and corresponding databases 407.

The one or more processes, steps, and/or APIs 440 that are executed at the data analytics environment 100 based on determined desired task may comprise executing one or more live data specific applications and corresponding databases 412. By way of example, a query for live data or information such as for example a query for a current stock price of securities trading on a stock market is executed using the one or more live data specific applications and corresponding databases 412.

In accordance with an example embodiment, the LLM 460 determines, based on the prompt 462 whether the one or more processes, steps, and/or APIs 440 that are executed at the data analytics environment 100 should recruit the services of the Oracle business productivity software applications and corresponding databases 406, or the one or more customer-specific applications and corresponding databases 407, or the one or more live data specific applications and corresponding databases 412, or combinations of the Oracle business productivity software applications and corresponding databases 406, the one or more customer-specific applications and corresponding databases 407 and/or the one or more live data specific applications and corresponding databases 412.

In accordance with an example embodiment, the LLM 460 together with the chat-assistance service 450 collaboratively determine, based on the query 452 and on the prompt 462 whether the one or more processes, steps, and/or APIs 440 that are executed at the data analytics environment 100 should recruit the services of the Oracle business productivity software applications and corresponding databases 406, or the one or more customer-specific applications and corresponding databases 407, or the one or more live data specific applications and corresponding databases 412, or combinations of the Oracle business productivity software applications and corresponding databases 406, the one or more customer-specific applications and corresponding databases 407 and/or the one or more live data specific applications and corresponding databases 412.

In any of the embodiments herein, the chat-assistance service 450 of the system is operable to receive a natural language query as the query 452 from a client such as for example from a client device 10. In the example embodiment, the query 452 may be provided to the chat-assistance service 450 from a chat-assisted interaction display pane of the user interface 12. The chat-assistance service 450 of the system is operable to translate the natural language query received from the client and/or from the client device 10 to a translated query, and to communicate the translated query to the LLM as the prompt 462.

In any of the embodiments herein, the LLM 460 of the system determines the desired task based on the prompt 462 received by the LLM 460, and executes the one or more processes, steps, and/or APIs of the determined desired task. In addition, the chat-assistance service 450 of the system provides results 454 of the LLM executing the one or more processes, steps, and/or APIs of the determined desired task. In the example embodiment, the results 454 are provided to a chat-assisted interaction display pane of the user interface 12.

In any of the embodiments herein, the LLM 460 of the system develops, based on training data and the prompt 462 received by the LLM, a response 464 representative of the determined desired task. In addition, the chat-assistance service 450 of the system receives the response 464 from the LLM 460 and executes the one or more processes, steps, and/or APIs of the determined desired task, and also provides results 464 of executing the one or more processes, steps, and/or APIs of the determined desired task.

In any of the embodiments herein, the system further includes an interface application 14 operably coupled with the chat-assistance service 450 running at the data analytics environment 100. In the embodiment, the interface application 14 of the system is operable to provide a user interface 12, to receive a job request from a client user via the user interface 12, and to deliver the received a job request 452 to the interface application 450 as the query.

In any of the embodiments herein, the system further includes an integration layer application 440 operably coupled with one or both of the chat-assistance service 450 and/or the LLM 460. In the embodiment, the integration layer application 440 provides a communication and control interface between one or both of the chat-assistance service 450 and/or the LLM 460 and application services internal or external to the data analytics environment. Also in the embodiment, one or both of the chat-assistance service 450 and/or the LLM 460 execute one or more of the APIs 440 of the determined desired task using the application services internal or external to the data analytics environment via the integration layer application.

In any of the embodiments herein, one or both of the chat-assistance service 450 and/or the LLM 460 automatically execute the one or more processes, steps, and/or APIs of the determined desired task. In the embodiment, the chat-assistance service 450 provides results 454 of the one or more processes, steps, and/or APIs of the determined desired task being automatically executed.

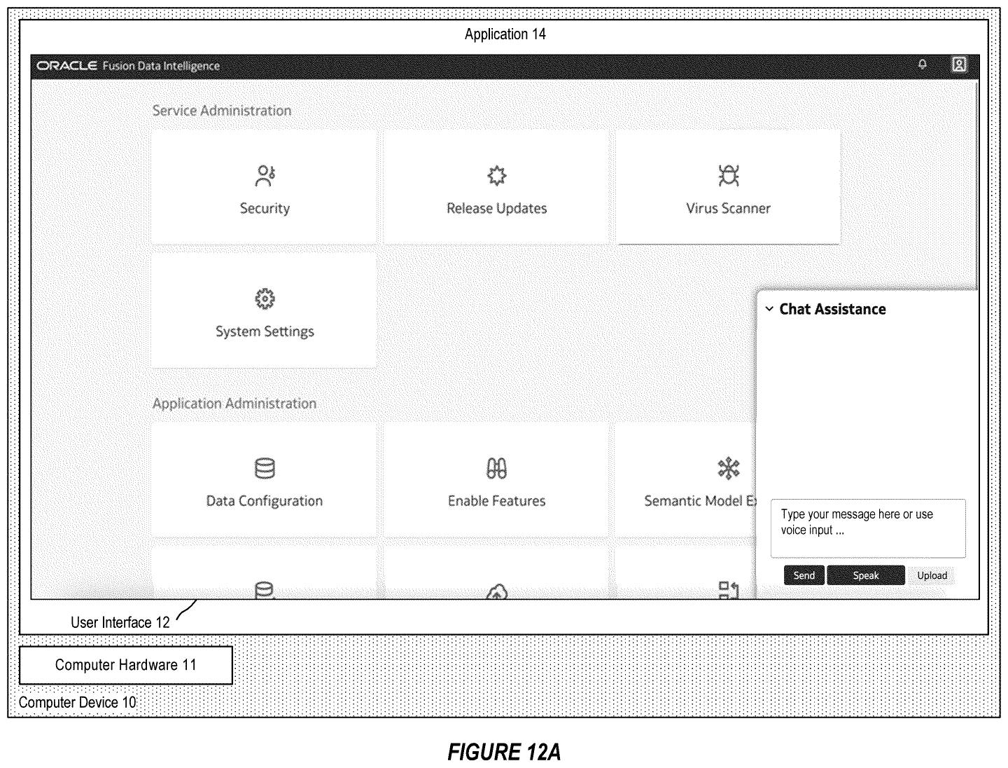

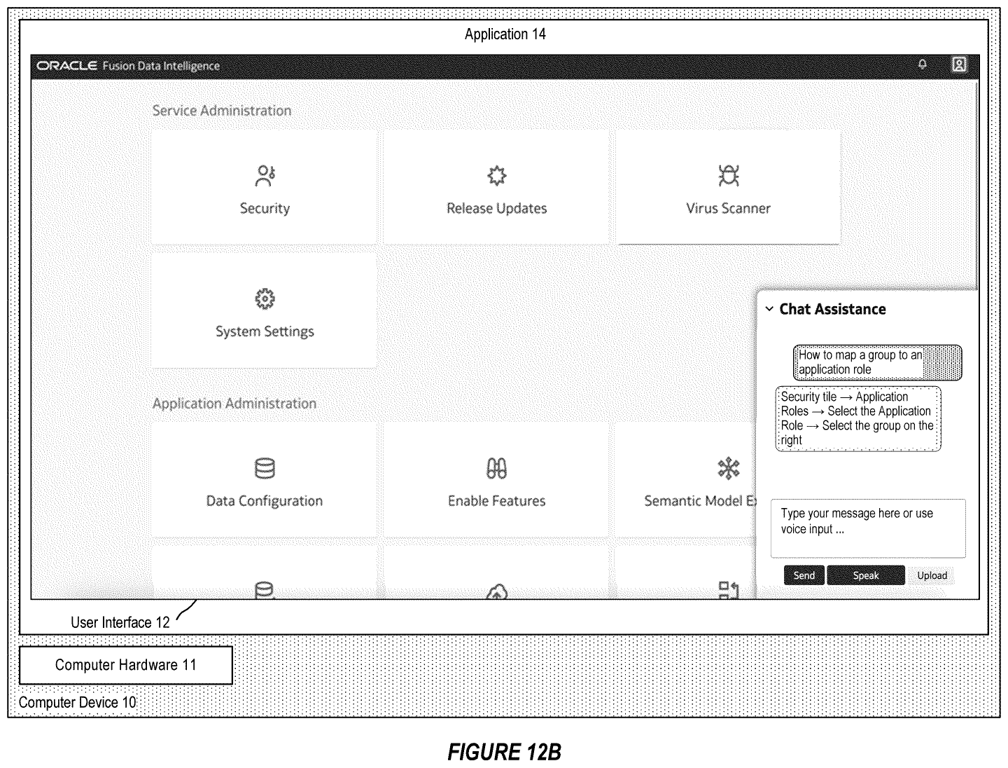

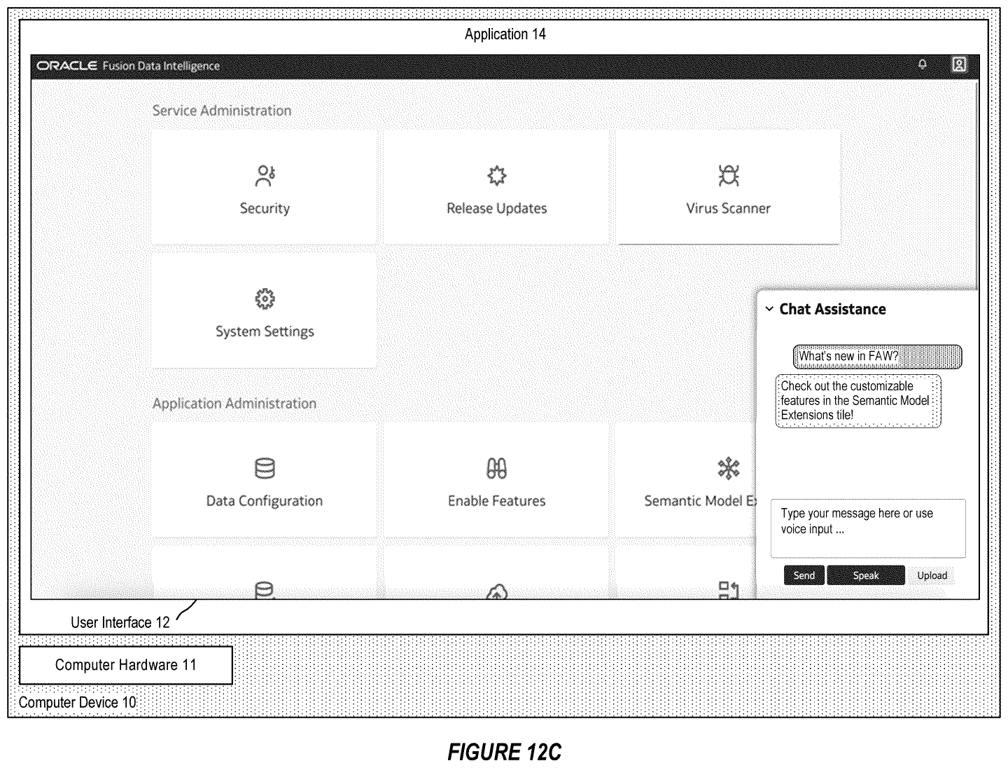

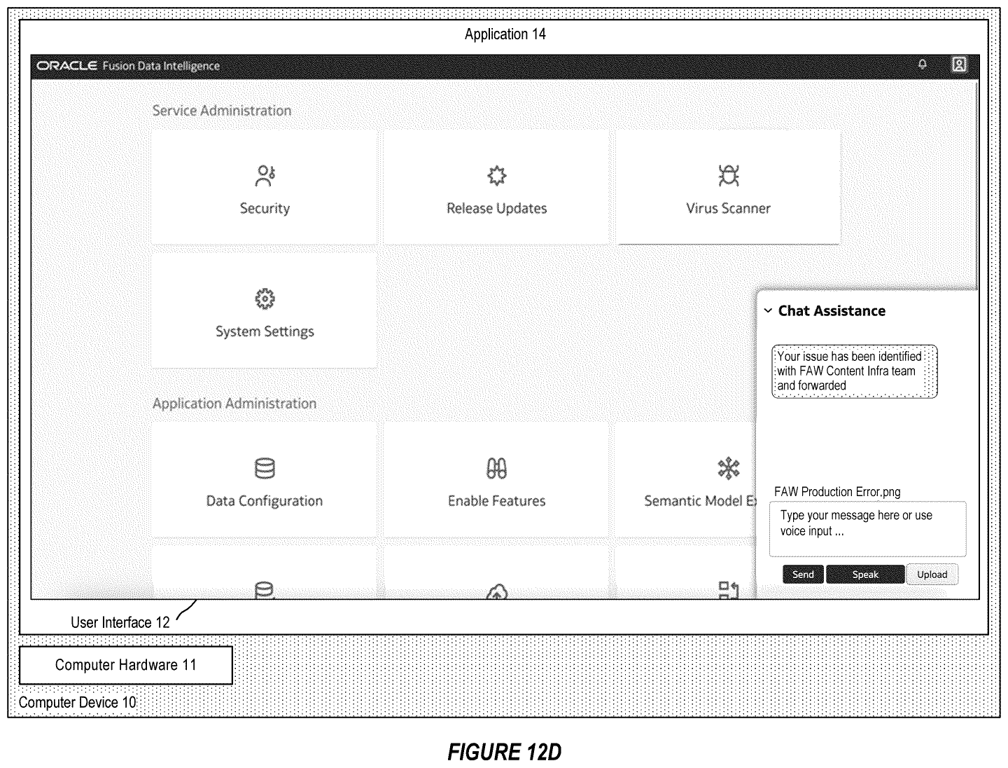

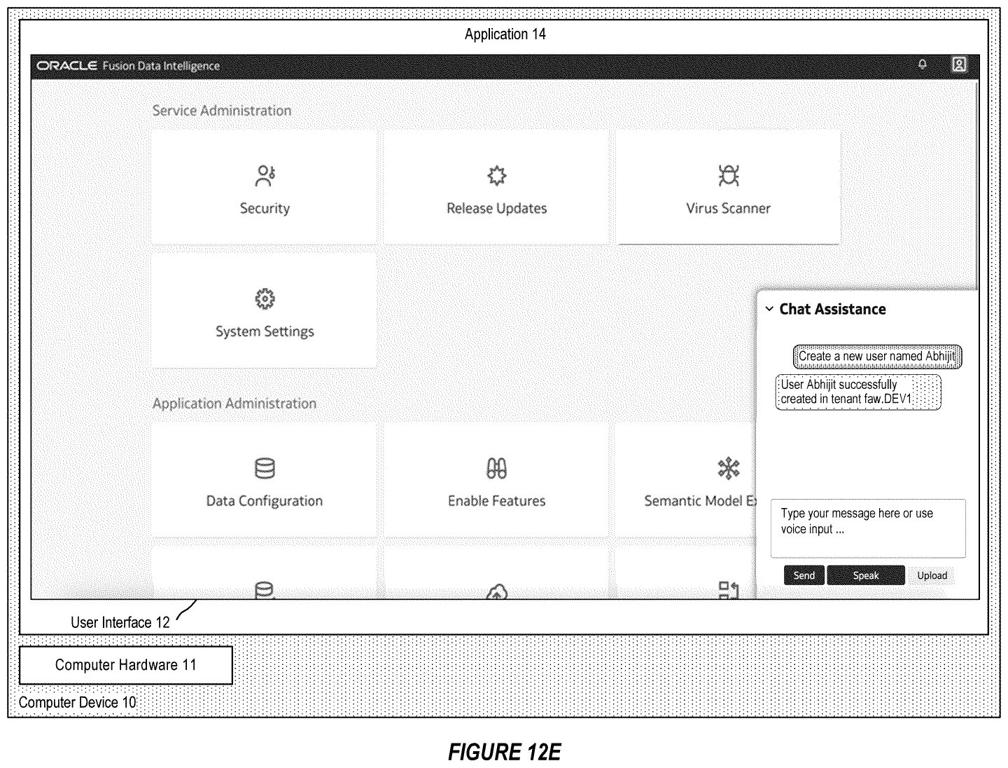

FIGS. 12A-12E illustrate screenshots produced by a system for use with a data analytics environment to provide an interactive digital assistant action interface, in accordance with an embodiment.

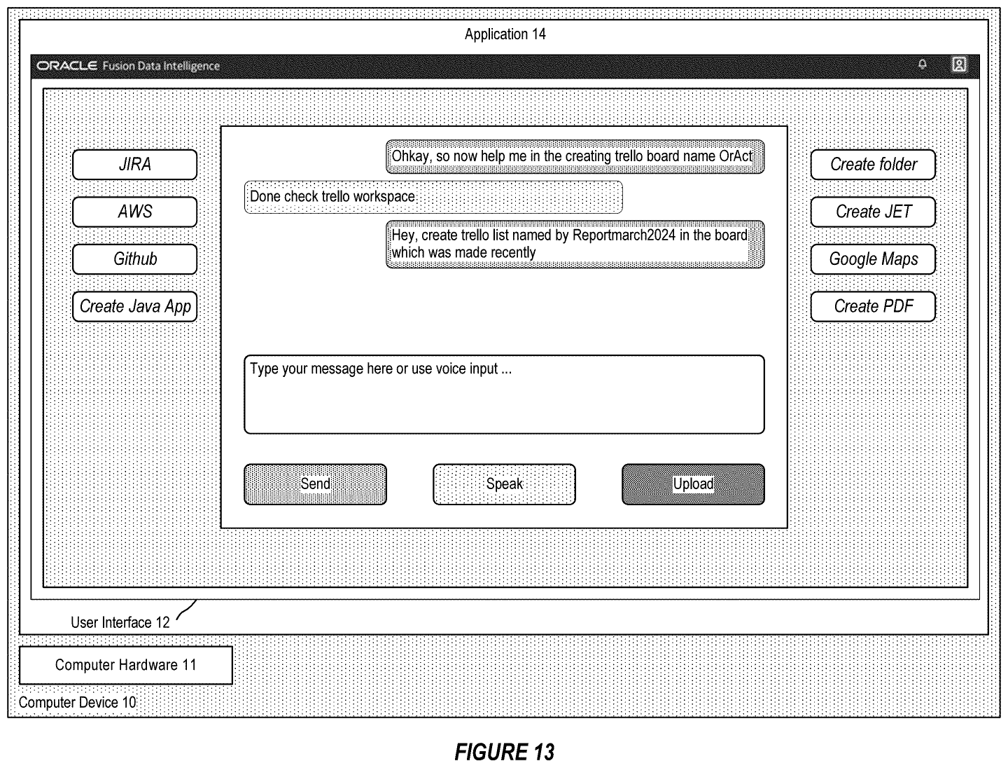

FIG. 13 illustrates a screenshot produced by a system for use with a data analytics environment to provide an interactive digital assistant action interface, in accordance with an embodiment.

In accordance with an embodiment, FIG. 13 shows a screenshot of an interactive digital assistant action interface where inputs are related to creating a board with a specific name and a list to be created within the board.

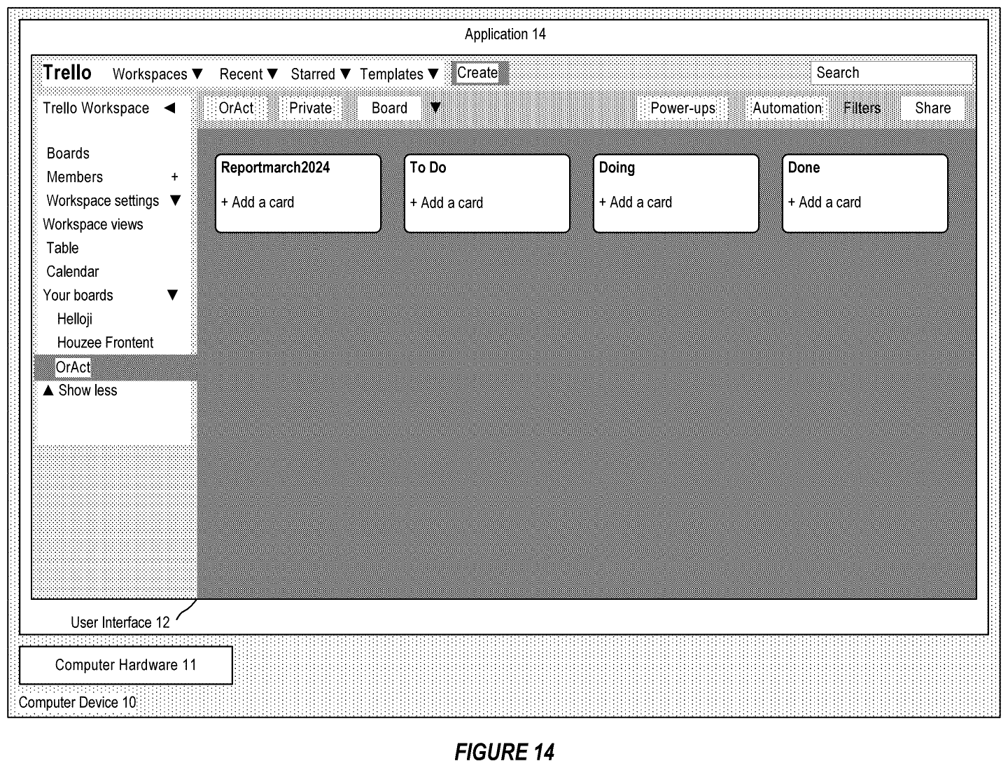

FIG. 14 illustrates a screenshot produced by a system for use with a data analytics environment to provide an interactive digital assistant action interface, in accordance with an embodiment.

In accordance with an embodiment, FIG. 14 shows a screenshot showing the results of the interactive digital assistant action interface of FIG. 13.

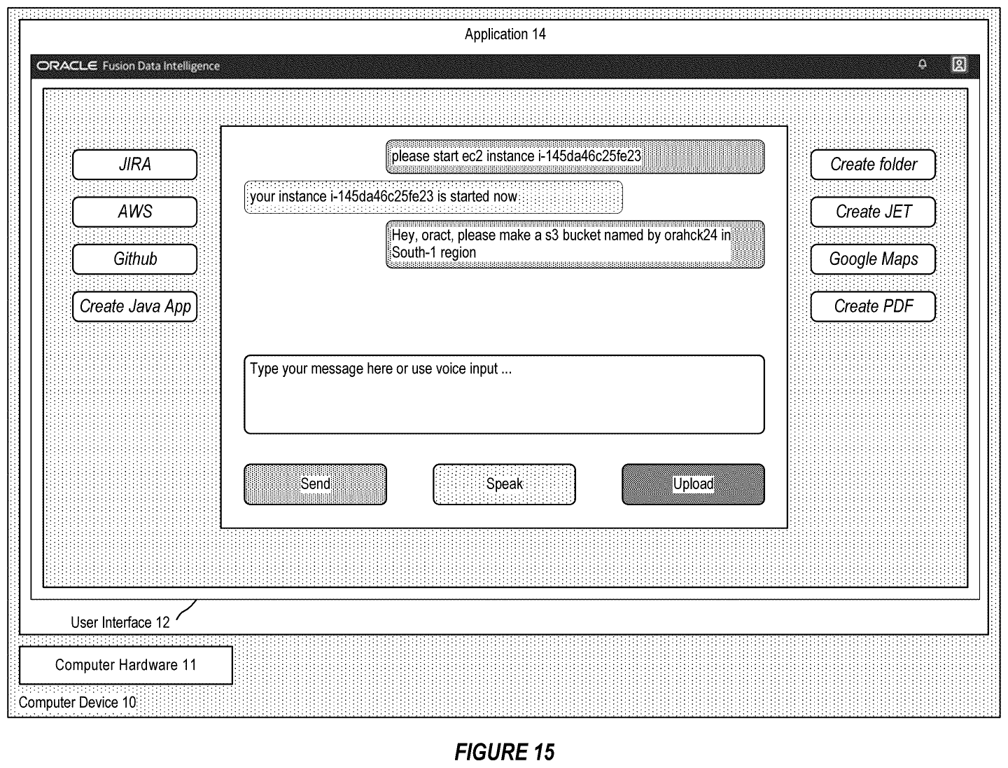

FIG. 15 illustrates a screenshot produced by a system for use with a data analytics environment to provide an interactive digital assistant action interface, in accordance with an embodiment.

In accordance with an embodiment, FIG. 15 shows a screenshot of an interactive digital assistant action interface where inputs are related to creating an instance with a certain ID, and creating a bucket within the instance.

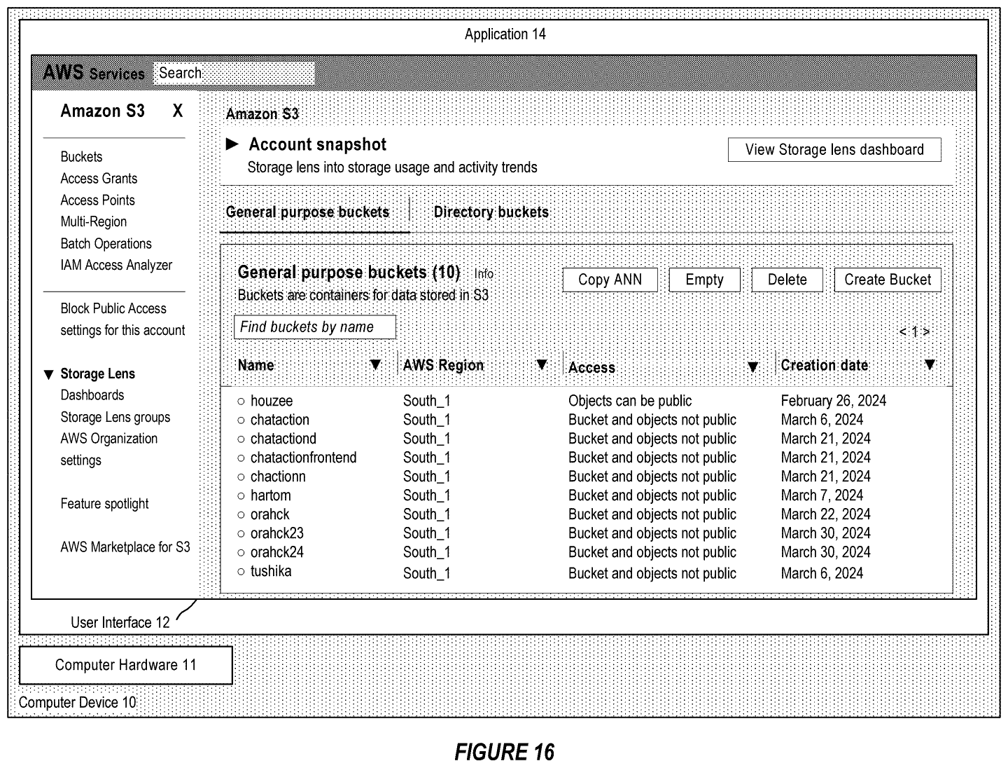

FIG. 16 illustrates a screenshot produced by a system for use with a data analytics environment to provide an interactive digital assistant action interface, in accordance with an embodiment.

In accordance with an embodiment, FIG. 16 shows a screenshot showing the results of the interactive digital assistant action interface of FIG. 15.

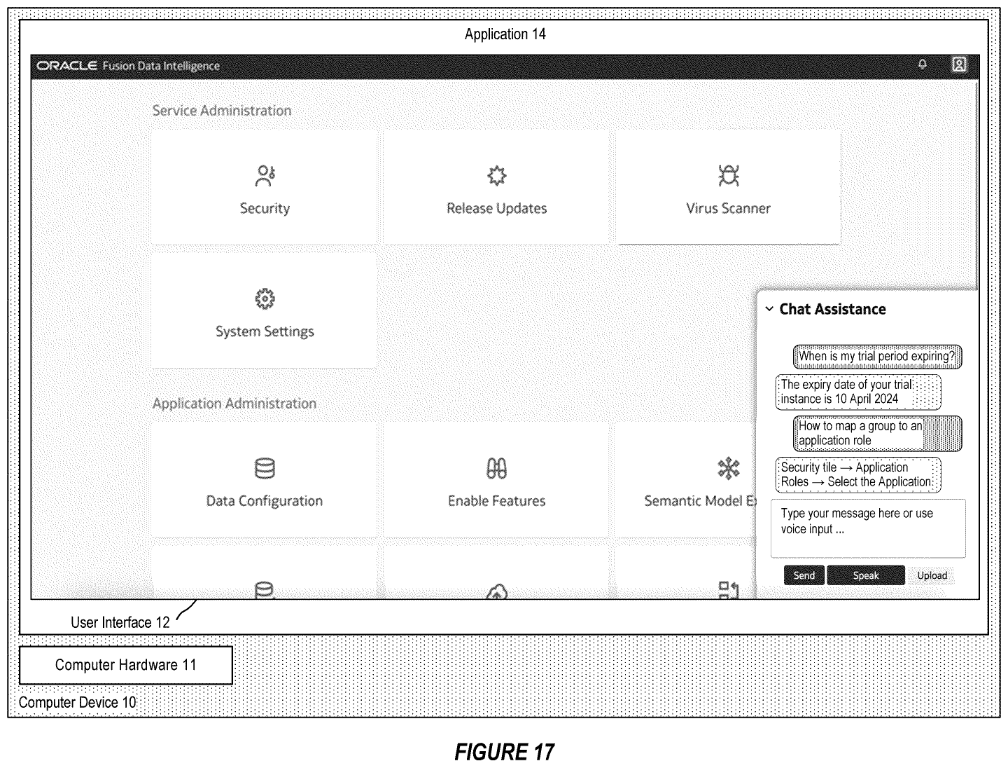

FIG. 17 illustrates a screenshot produced by a system for use with a data analytics environment to provide an interactive digital assistant action interface, in accordance with an embodiment.

In accordance with an embodiment, FIG. 17 shows a screenshot of an interactive digital assistant action interface within a data analytics environment.

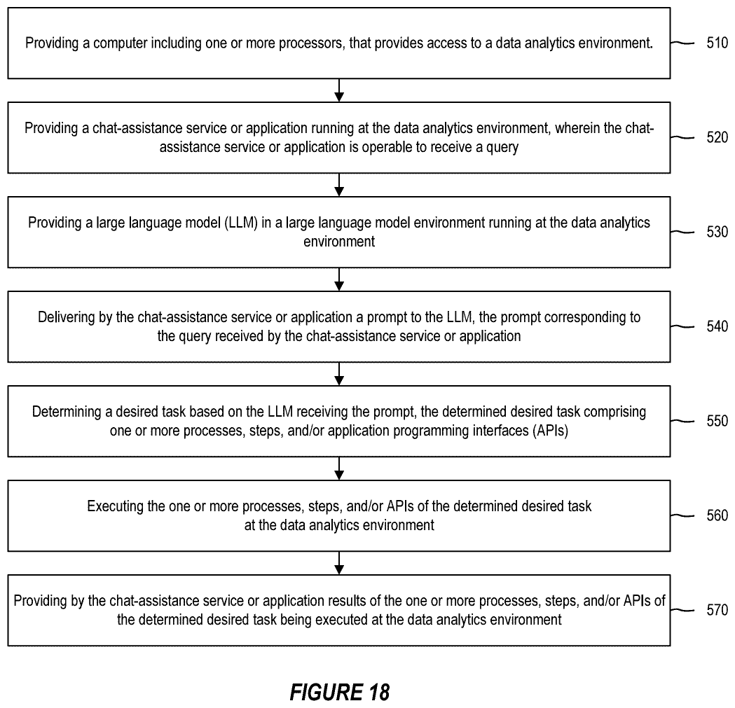

FIG. 18 illustrates a flowchart of a method for use with a data analytics environment to provide an interactive digital assistant action interface for use with a data analytics environment, in accordance with an embodiment.

The method in accordance with an example embodiment includes providing at step 510 a computer including one or more processors, that provides access to a data analytics environment.

The method in accordance with the example embodiment further includes providing at step 520 a chat-assistance service running at the data analytics environment, wherein the chat-assistance service or application is operable to receive a query.

The method in accordance with the example embodiment further includes providing at step 530 a large language model (LLM) in a large language model environment running at the data analytics environment.

The method in accordance with the example embodiment further includes delivering at step 540 by the chat-assistance service or application a prompt to the LLM, the prompt corresponding to the query received by the chat-assistance service or application.

The method in accordance with the example embodiment further includes determining at step 550 a desired task based on the LLM receiving the prompt, the determined desired task comprising one or more processes, steps, and/or application programming interfaces (APIs).

The method in accordance with the example embodiment further includes executing at step 560 the one or more processes, steps, and/or APIs of the determined desired task the data analytics environment.

The method in accordance with the example embodiment further includes providing at step 570 by the chat-assistance service or application results of the one or more processes, steps, and/or APIs of the determined desired task being executed at the data analytics environment.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment to provide an interactive digital assistant action interface, the system comprising:
a computer including one or more processors, that provides access to a data analytics environment;
a chat-assistance service or application running at the data analytics environment, wherein the chat-assistance service or application is operable to receive a query; and
a large language model (LLM) in a large language model environment running at the data analytics environment,
wherein the chat-assistance service or application delivers to the LLM a prompt corresponding to the query received by the chat-assistance service or application,
wherein a desired task is determined based on the LLM receiving the prompt, the determined desired task comprising one or more processes, steps, and/or application programming interfaces (APIs),
wherein the one or more processes, steps, and/or APIs of the determined desired task are executed at the data analytics environment,
wherein the chat-assistance service or application provides results of the one or more processes, steps, and/or APIs of the determined desired task being executed at the data analytics environment.

2. The system according to claim 1, wherein:
the chat-assistance service or application is operable to receive a natural language query from a client device;
the chat-assistance service or application is operable to translate the natural language query received from the client device to a translated query; and
the chat-assistance service or application is operable to communicate the translated query to the LLM as the prompt.

3. The system according to claim 1, wherein:
the LLM determines the desired task based on the prompt received by the LLM;
the LLM executes the one or more processes, steps, and/or APIs of the determined desired task; and
wherein the chat-assistance service or application provides results of the LLM executing the one or more processes, steps, and/or APIs of the determined desired task.

4. The system according to claim 1, wherein:
the LLM develops, based on training data and the prompt received by the LLM, a response representative of the determined desired task;
the chat-assistance service or application receives the response from the LLM and executes the one or more processes, steps, and/or APIs of the determined desired task; and
wherein the chat-assistance service or application provides results of executing the one or more processes, steps, and/or APIs of the determined desired task.

5. The system according to claim 1, further comprising:
an interface application operably coupled with the chat-assistance service or application running at the data analytics environment,
wherein the interface application is operable to provide a user interface,
wherein the interface application is operable to receive a job request from a client user via the user interface,
wherein the interface application is operable to deliver the received a job request to the interface application as the query.

6. The system according to claim 1, further comprising:
an integration layer application operably coupled with one or both of the chat-assistance service or application and/or the LLM,
wherein the integration layer application provides a communication and control interface between one or both of the chat-assistance service or application and/or the LLM and application services internal or external to the data analytics environment,
wherein one or both of the chat-assistance service or application and/or the LLM execute one or more of the APIs of the determined desired task using the application services internal or external to the data analytics environment via the integration layer application.

7. The system according to claim 1, wherein:
one or both of the chat-assistance service or application and/or the LLM automatically execute the one or more processes, steps, and/or APIs of the determined desired task; and
the chat-assistance service or application provides results of the one or more processes, steps, and/or APIs of the determined desired task being automatically executed.

8. A method for use with a data analytics environment to provide an interactive digital assistant action interface, the method comprising:
providing a computer including one or more processors, that provides access to a data analytics environment;
providing a chat-assistance service or application running at the data analytics environment, wherein the chat-assistance service or application is operable to receive a query;
providing a large language model (LLM) in a large language model environment running at the data analytics environment;
delivering by the chat-assistance service or application a prompt to the LLM, the prompt corresponding to the query received by the chat-assistance service or application;
determining a desired task based on the LLM receiving the prompt, the determined desired task comprising one or more processes, steps, and/or application programming interfaces (APIs);
executing the one or more processes, steps, and/or APIs of the determined desired task the data analytics environment; and
providing by the chat-assistance service or application results of the one or more processes, steps, and/or APIs of the determined desired task being executed at the data analytics environment.

9. The method according to claim 8, further comprising:
receiving by the chat-assistance service or application a natural language query from a client device;
translating by the chat-assistance service or application the natural language query received from the client device to a translated query; and
communicating by the chat-assistance service or application the translated query to the LLM as the prompt.

10. The method according to claim 8, further comprising:
determining by the LLM the desired task based on the prompt received by the LLM;
executing by the LLM the one or more processes, steps, and/or APIs of the determined desired task; and
providing by the chat-assistance service or application results of the LLM executing the one or more processes, steps, and/or APIs of the determined desired task.

11. The method according to claim 8, further comprising:
developing by the LLM, based on training data and the prompt received by the LLM, a response representative of the determined desired task;
receiving by the chat-assistance service or application the response from the LLM and executing by the chat-assistance service or application the one or more processes, steps, and/or APIs of the determined desired task; and
providing by the chat-assistance service or application results of executing the one or more processes, steps, and/or APIs of the determined desired task.

12. The method according to claim 8, further comprising:
providing an interface application operably coupled with the chat-assistance service or application running at the data analytics environment;
providing by the interface application a user interface;
receiving by the interface application a job request from a client user via the user interface; and
delivering by the interface application the received a job request to the interface application as the query.

13. The method according to claim 8, further comprising:
providing an integration layer application operably coupled with one or more of the chat-assistance service or application and/or the LLM;
providing by the integration layer application a communication and control interface between one or more of the chat-assistance service or application and/or the LLM and application services internal or external to the data analytics environment; and
executing, by one or both of the chat-assistance service or application and/or the LLM, one or more of the APIs of the determined desired task using the application services internal or external to the data analytics environment via the integration layer application.

14. The method according to claim 8, further comprising:
automatically executing, by one or both of the chat-assistance service or application and/or the LLM, the one or more processes, steps, and/or APIs of the determined desired task; and
providing by the chat-assistance service or application results of the one or more processes, steps, and/or APIs of the determined desired task being automatically executed.

15. A non-transitory computer readable medium having instructions thereon for use with a data analytics environment to provide an interactive digital assistant action interface, that when run and executed cause the computer to perform steps comprising:
providing a computer including one or more processors, that provides access to a data analytics environment;
providing a chat-assistance service or application running at the data analytics environment, wherein the chat-assistance service or application is operable to receive a query;
providing a large language model (LLM) in a large language model environment running at the data analytics environment;
delivering by the chat-assistance service or application a prompt to the LLM, the prompt corresponding to the query received by the chat-assistance service or application;
determining a desired task based on the LLM receiving the prompt, the determined desired task comprising one or more processes, steps, and/or application programming interfaces (APIs);
executing the one or more processes, steps, and/or APIs of the determined desired task the data analytics environment; and
providing by the chat-assistance service or application results of the one or more processes, steps, and/or APIs of the determined desired task being executed at the data analytics environment.

16. The non-transitory computer readable medium according to claim 15, wherein the instructions thereon when run and executed cause the computer to perform further steps comprising:
receiving by the chat-assistance service or application a natural language query from a client device;
translating by the chat-assistance service or application the natural language query received from the client device to a translated query; and
communicating by the chat-assistance service or application the translated query to the LLM as the prompt.

17. The non-transitory computer readable medium according to claim 15, wherein the instructions thereon when run and executed cause the computer to perform further steps comprising:
determining by the LLM the desired task based on the prompt received by the LLM;
executing by the LLM the one or more processes, steps, and/or APIs of the determined desired task; and
providing by the chat-assistance service or application results of the LLM executing the one or more processes, steps, and/or APIs of the determined desired task.

18. The non-transitory computer readable medium according to claim 15, wherein the instructions thereon when run and executed cause the computer to perform further steps comprising:
developing by the LLM, based on training data and the prompt received by the LLM, a response representative of the determined desired task;
receiving by the chat-assistance service or application the response from the LLM and executing by the chat-assistance service or application the one or more processes, steps, and/or APIs of the determined desired task; and
providing by the chat-assistance service or application results of executing the one or more processes, steps, and/or APIs of the determined desired task.

19. The non-transitory computer readable medium according to claim 15, wherein the instructions thereon when run and executed cause the computer to perform further steps comprising:
providing an interface application operably coupled with the chat-assistance service or application running at the data analytics environment;
providing by the interface application a user interface;
receiving by the interface application a job request from a client user via the user interface; and
delivering by the interface application the received a job request to the interface application as the query.

20. The non-transitory computer readable medium according to claim 15, wherein the instructions thereon when run and executed cause the computer to perform further steps comprising:
providing an integration layer application operably coupled with one or more of the chat-assistance service or application and/or the LLM;
providing by the integration layer application a communication and control interface between one or more of the chat-assistance service or application and/or the LLM and application services internal or external to the data analytics environment;
executing, by one or both of the chat-assistance service or application and/or the LLM, one or more of the APIs of the determined desired task using the application services internal or external to the data analytics environment via the integration layer application;
automatically executing, by one or both of the chat-assistance service or application and/or the LLM, the one or more processes, steps, and/or APIs of the determined desired task; and
providing by the chat-assistance service or application results of the one or more processes, steps, and/or APIs of the determined desired task being automatically executed.
